(19) United States
(12) Patent Application Publication
(10) Pub. No.: US 2008/0253669 A1
(43) Pub. Date: Oct. 16, 2008

(54) IMAGE PROCESSING METHOD AND IMAGE DISPLAY APPARATUS USING THE SAME

(76) Inventors: Koichi HAMADA, Yokohama (JP); Mitsuo Nakajima, Yokohama (JP); Yasuhiro Akiyama, Ome (JP); Hideharu Hattori, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/099,972

(22) Filed: Apr. 9, 2008

(30) Foreign Application Priority Data
Apr. 11, 2007 (JP) 2007-103803

(51) Int. Cl. G06K 9/36

(52) U.S. Cl. 382/236; 375/240.16

(57) ABSTRACT

According to the present invention, it is possible to carry out the optimum correction of moving images in the frame even if the movement of objects in the frame is not uniform in a subfield light-emitting type display. The motion vector detecting module detects the motion vector of pixels among the frames relating to the input image signal. The motion vector correcting module replaces the motion vectors V of all the pixels in the frame with a specific motion vector Vm, when the distribution of the motion vectors V in the frame detected is biased to the specific motion vector Vm. The subfield correcting module corrects the light-emitting positions of the subfield light-emitting pattern according to the motion vectors outputted by the motion vector correcting module.

### CLAIM OF PRIORITY

The present application claims priority from Japanese application serial No. JP 2007-103803, filed on Apr. 11, 2007, the content of which is hereby incorporated by reference into this application.

### BACKGROUND OF THE INVENTION

(1) Field of the Invention

This invention relates to the image processing technology of an image display apparatus for displaying multiple tone image by dividing a frame into a plurality of subfields in a time-sharing manner and illuminating the subfields corresponding to the luminosity level of the input image signal.

(2) Description of the Related Art

Plasma display panels (PDP) and liquid crystal displays (LCD) attract attention as slim and light-weight display apparatuses. The driving method of the PDP is completely different from the conventional CRT driving method and is a direct driving method by digitalized input image signals. Therefore, the luminosity tone illuminated from the panel surface is determined by the number of bits of the signal treated. According to the address/display separation type driving method, in the case of an 8-bit signal for example, a frame is constituted by eight subfields SF1-SF8 whose relative ratio of luminosity is 1, 2, 4, 8, 16, 32, 64, and 128, and 256 tones of display can be realized by combining the luminosity of eight subfields.

When moving images are displayed by a display apparatus of the address/display separation type driving method described above, since the input image signal (original signal) is a discrete signal sampled for each frame, and a problem develops in that visual displacement widens in the displacement direction of moving images causing a degradation in the quality of images, or the presence of levels that do not agree with the original signals causes a degradation in the quality of images. This phenomenon is called “pseudo-profile of moving image,” and in order to solve this problem the following method of correcting moving images has been proposed in the past.

JP-A No. 10-282930 discloses the detection of motion vectors of pixels in one frame or among a plurality of frames based on an input image signal, and the output of the signal obtained by correcting the input image signal by a high-speed moving image correcting means or the signal obtained by correcting the input image signal by a slow-speed moving image correcting means chosen by switching depending on whether the magnitude of the motion vector detected is larger than the set value S. And JP-A No. 2002-123211 discloses the method of re-encoding by calculating the motion vector of pixels and by calculating the drug coordinate of the new subfield codeword of the current pixel based on the motion vector. According to these methods, the movement of objects within the image is assumed and the position of light-emitting of pixels in the moving region is disposed by adjusting to the movement of the objects. In other words, the lighting position of the subfield of moving pixel is gradually shifted to the position of other pixels by adjusting to the movement of eyes.

### SUMMARY OF THE INVENTION

According to the art disclosed in JP-A No. 10-282930 or JP-A No. 2002-123211 described above, when the whole frame moves in the same direction or in other cases in which the motion vector is known, it is possible to effectively remove the pseudo-profile of moving images. However, the inventors of this invention have discovered a problem in that a new pseudo-profile develops in images other than the observation point when the movement of the whole frame is not uniform.

In other words, since the illuminating points are respectively corrected in search of a motion vector for each object in the frame, the elimination effect of pseudo-profile can be obtained only on the object to which the eyes follow (observation point). When there are other objects having a motion vector different from the observation point (or still objects) in the neighborhood of the observation point in the frame, the movement of other objects does not agree with the movement of eyes, and a pseudo-profile develops on the contrary on other objects, and they are observed with an odd feeling.

Or in a scrolling image or the like where almost all the pixels of the whole frame displace in the horizontal direction or in the vertical direction, if there is any small object moving in a direction different from the scrolling direction, the illuminating position of the small object is corrected in a direction different from the direction of eyes movement, and as a result a pseudo-profile develops likewise.

Incidentally, we have heard of an art in which the reliability of the detected value is determined by using the histogram of the motion vector and correcting the same where it is necessary in order to make the detected value harmonious with the movement in the environment. However, this art is designed to enhance the precision of the detected value of the vector itself, and cannot be used to reduce the pseudo-profile of moving images described above.

This invention has been made in view of the problem described above, and aims to provide an image processing method and an image display apparatus using the same, capable of making the optimum compensation of moving images when the movement of objects in the frame is not uniform in a subfield light-emitting type display.

The image processing method according to this invention includes the steps of dividing a frame into a plurality of subfields in a time-sharing manner, converting the same into a subfield light-emitting pattern corresponding to the luminosity level of the input image signals, detecting the motion vectors of pixels between frames relating to the input image signals, and correcting the light-emitting positions of the subfield light-emitting pattern corresponding to the motion vectors detected, and when the distribution of motion vector V in the frame is concentrated to a particular motion vector Vm, the motion vectors V of all the pixels in the frame are replaced with the specific motion vector Vm, and then the light-emitting positions of the subfield light-emitting pattern are corrected.

And the image display apparatus according to this invention includes a subfield converting module which divides a frame into a plurality of subfields in a time-sharing manner and converts the same into a subfield light-emitting pattern corresponding to the luminosity level of the input image signal, a motion vector detecting module which detects the motion vectors V of pixels among frames in relation to the input image signal, a motion vector correcting module which replaces the motion vectors V of all the pixels in the frame with a specific motion vector Vm when the distribution of motion vectors V within the frame detected by the motion vector detecting module is concentrated to a specific motion vector Vm, and a subfield correcting module which corrects the light-emitting positions of the subfield light-emitting pattern converted by the subfield converting module according to the motion vector output from the motion vector correcting module.

According to this invention, it is possible to provide images of a good quality even if the movement of objects in the frame is not uniform in the subfield light-emitting display.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing an embodiment of the image display apparatus according to the present invention;

FIG. 2 is an illustration showing an example of the internal configuration of the image processing module 2 in FIG. 1;

FIGS. 3A and 3B are illustrations describing the operation of the histogram counting module 26 in FIG. 2;

FIG. 4 is an illustration showing an example of the internal structure of the motion vector correcting module 25;

FIG. 5 is an illustration showing the conversion to the subfield light-emitting pattern for displaying multiple tone images;

FIG. 6 is an illustration showing schematically the method of correcting subfield lighting positions;

FIG. 7 is an illustration showing another example of configuration of the image processing module 2 in FIG. 1;

FIGS. 8A and 8B are illustrations describing the compensation of a motion vector by a low pass filter 29;

FIG. 9 is an illustration showing a still another example of configuration of the image processing module in FIG. 1; and

FIG. 10 is a block diagram showing another embodiment of the image display apparatus according to the present invention.

### DETAILED DESCRIPTION OF THE EMBODIMENT

We will describe below the embodiments of the present invention with reference to drawings.

### First Embodiment

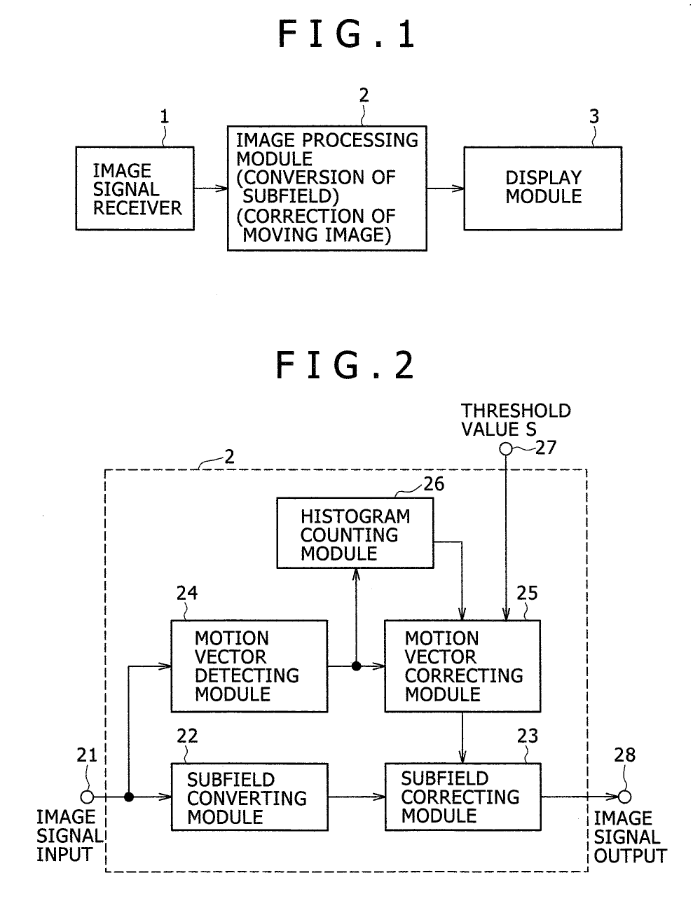

FIG. 1 is a block diagram showing an embodiment of the image display apparatus according to the present invention. Any broadcast wave (airwave) or image signal transmitted through a network or the like is received by the image signal receiving module 1, which selects the desired channel. And image signals converted into a compressed code are decoded back to image signals as required. The image processing module 2 converts image signals to subfield image signals for displaying multiple tone images and corrects moving image to remove the pseudo-profile described below. The subfield image signal is supplied to the display module 3 constituted by a PDP and the like where the image is to be displayed.

FIG. 2 is an illustration showing an example of the internal configuration of the image processing module 2. The terminal 21 is the point where image signal arriving from the image signal receiving module 1 is inputted.

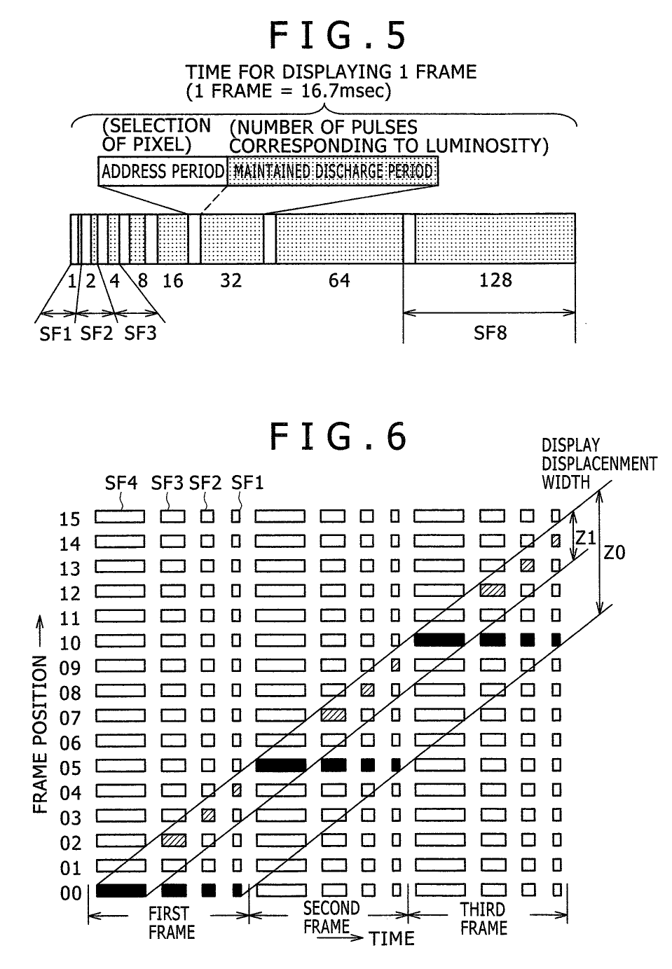

The subfield converting module 22 converts the image signal into the subfield light-emitting pattern suitable thereto to display multiple tone images in the subfield light-emitting type display module 3 constituted by a PDP and the like. For example, as shown in FIG. 5, it divides a frame into eight subfields SF1-SF8 with a relative ratio of luminosity of 1, 2, 4, 8, 16, 32, 64, and 128 by using 8-bit signals, and displays 256 tones by the combination of luminosity in eight divided frames.

The motion vector detecting module 24 detects the motion vector V for each pixel or each block from the inputted image signal. It is possible to obtain from this motion vector the information of moving speed and moving direction of objects. With regards to the art of detecting movement or the art of estimating movement for detecting the motion vector, we omit description thereof here, because it is possible to apply the well-known art used in the MPEG encoding process.

The histogram counting module 26 counts the frequency of appearance of the motion vectors V detected by the motion vector detecting module 24 for each component in the horizontal direction and the vertical direction. Here, when the horizontal component of the motion vector of a pixel is represented by Vx and the vertical component of the same is represented by Vy, the motion vector of the pixel is represented by V=(Vx, Vy). The histogram of the motion vector shows how many motion vectors having respective component are in a certain region with a distribution chart. And when the distribution of motion vectors is concentrated in a specific motion vector, we express that a “bias” has developed in the specific motion vector.

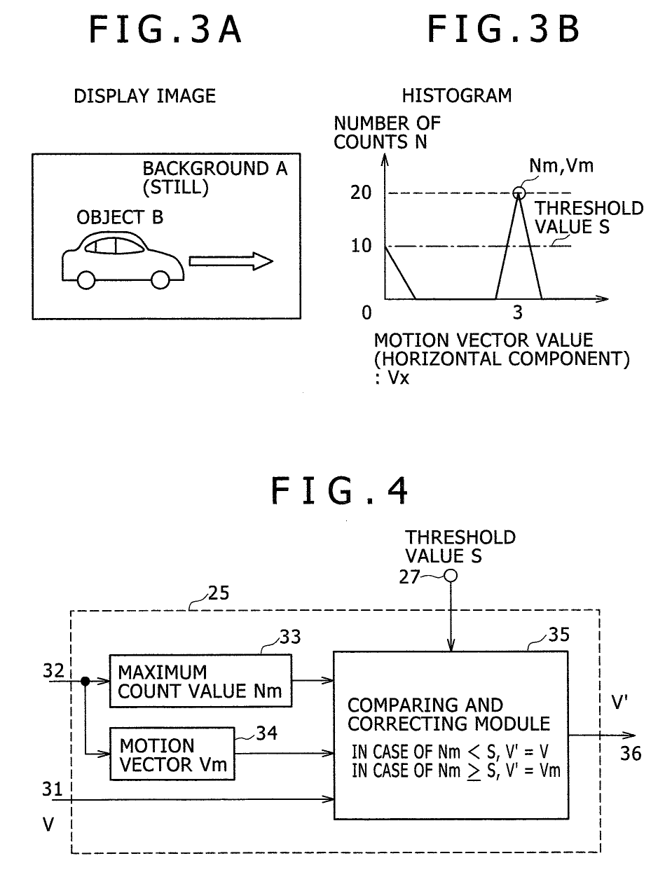

FIGS. 3A and 3B are illustrations describing the operation of the histogram counting module 26. As an example, as shown in FIG. 3A, let us assume a frame in which an object B is moving in the horizontal direction against an almost still background A. FIG. 3B shows the histogram of motion vectors in the frame obtained for such a frame. The horizontal axis represents the magnitude of the horizontal component Vx, and the vertical axis represents the number of counts N. In this figure, a distribution biased to specific motion vectors Vx=0 (number of counts N=10) and Vx=3 (number of counts N=20), and the number of counts N indicates the intensity of bias. Incidentally, it is needless to say that Vx=0 corresponds to the image of a still background A, and Vx=3 corresponds to the image of a moving object B. And as the magnitude of the object B grows larger, the number of counts N of Vx=3 grows larger, and the intensity of bias grows stronger. In other words, the magnitude of object in relation to the frame shows up as the intensity of bias. And if the number of counts at which the number of counts N (bias) becomes the maximum is represented by Nm, in this case, the count of numbers will be the maximum value Nm=20 at a specific motion vector Vx=3.

The motion vector correcting module 25 corrects the motion vector value V detected by the motion vector detecting module 24 to V′ in response to the count value N (bias) of each motion vector obtained by the histogram counting module 26 and outputs the same to the subfield correcting module 23.

FIG. 4 is an illustration showing an example of the internal configuration of the motion vector correcting module 25. In this embodiment, when, as a result of having obtained the maximum value Nm (maximum bias) of the count value N of each motion vector and the value Vm of the specific motion vector at that moment, the maximum count value Nm is equal to or larger than the preset threshold value S, the motion vector value V detected by the motion vector detecting module 24 is corrected by replacing the same with V′=Vm.

Upon obtaining histogram information 32 from the histogram counting module 26, the register 33 holds the maximum value Nm of the count value N, and the register 34 holds the value Vm of the specific motion vector that gives the maximum count value Nm. The comparative correcting module 35 compares the maximum count value Nm with the threshold value S inputted by the terminal 27. And if the maximum count value Nm is equal or larger than the threshold value S, all the motion vectors V (code 31) detected by the motion vector detecting module 24 in the region (the region where the histogram is counted) are corrected (V′=Vm) by replacing the same with the value Vm of the specific motion vector. The motion vectors V′ (code 36) thus corrected are outputted into the subfield correcting module 23. If the maximum count value Nm is smaller than the threshold value S, the motion vectors V detected by the motion vector detecting module 23 are outputted as they are (V′=V).

For example, in the case of FIG. 3 described above, the maximum count value Nm is 20 (Nm=20), and supposing that the threshold value S is 10, Nm>S, and therefore the motion vector of the whole frame is corrected to be V′=Vm (Vx=3) and is outputted accordingly.

Now, the threshold value S is set as considered proper in the circumstance from the visual characteristics of humans. For example, with regard to area ratio, it is preferable to set the value at 20% to 50% of the area. And when there are a plurality of moving objects and their speed is different, or in the case of a single object whose speed is distributed, the maximum count value Nm and the value Vm of the specific motion vector may be calculated by averaging their moving speed and considering that the whole object is moving at the average speed.

The subfield correcting module 23 corrects the lighting position of the subfield by using the information of the motion vectors corrected by the motion vector correcting module 25. It is possible to remove pseudo-profiles at the time of displaying moving images by this correction. The corrected image signals (subfield data) are outputted into the display module 3 from the terminal 28.

FIG. 6 is an illustration showing schematically the method of correcting the lighting positions of the subfield carried out by the subfield correcting module 23. This shows a case where, for the sake of simplification, a frame is constituted by four subfields (SF1-SF4), and a frame is lit up in the order of SF4→SF3→SF2→SF1. The horizontal axis represents time and the vertical axis represents position in the frame. In this figure, let us suppose that an object of attention moves from the frame position 00 of the first frame to the frame position 05 in the second frame and to the frame position 10 in the third frame. The subfield signal outputted from the subfield converting module 22 causes the identical positions (the parts daubed completely black in drawing) to be illuminated in each subfield during each frame period. As a result, a visual displacement width Z0 occurs when a moving object is observed through consecutive frames, and this can cause the generation of a pseudo profile. In such a case, in this embodiment, the light-emitting position in each subfield is corrected so that it may be disposed along an oblique straight line showing the movement of the object (movement straight line, visual line pass) (shaded portion in drawing). As a result, the visual displacement width Z0 is reduced to Z1 and the pseudo profile can be contained. And the visual displacement width can be minimized by determining the slope of the movement straight line chosen as the standard for disposition in accordance to the speed of the object, in other words the detected motion vector.

In this embodiment, the motion vector correcting module 25 corrects the motion vector detected by the motion vector detecting module 24 and supplies the same to the subfield correcting module 23. At that time, if the movement of the whole frame is not uniform and the bias of the motion vector is large (in other words, when the size of the moving object is large), the light-emitting positions of the subfield are corrected by considering that the whole frame is moving in the same way as the object is. As a result, even when there are other objects having a different motion vector from the observation point (or still objects) around the observation point, the other objects are free of any possible occurrence of pseudo profile and the whole frame can be observed without any feeling of strangeness.

In this embodiment, the motion vectors in the whole frame are corrected based on the histogram count value of the whole frame. But this is not the exclusive method, and the frame may be divided into a plurality of regions, and in each region the histogram count value may be counted and the vector may be corrected accordingly.

### Second Embodiment

FIG. 7 is an illustration showing another example of configuration of the image processing module 2 described in FIG. 1. In this embodiment, as a part of the constitution of the image processing module 2 of the first embodiment (FIG. 2), the function of the motion vector correcting module 25 is realized by a low-pass filter 29. And the low-pass filter 29 is controlled according to the result of the histogram count. The spatial changes of the motion vectors are mitigated by spatial low-pass filter processing implemented over the whole frame or the whole region with the low-pass filter 29 in response to the motion vectors of the objects detected by the motion vector detecting module 24. In other words, the motion vectors in the peripheral region of the observation point (moving objects) are set in harmony with the motion vectors of the observation points in order to remove pseudo profiles that develop in the peripheral region.

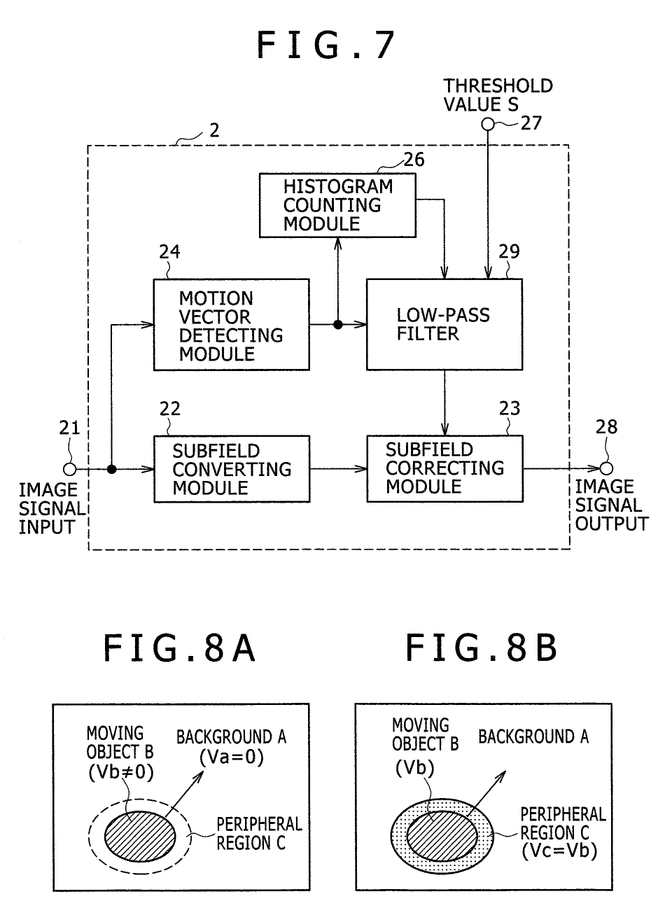

FIGS. 8A and 8B are illustrations describing the correction of motion vectors by the low-pass filter 29. For example, when the object B in drawing moves in arrow direction (motion vector Vb≈0) against the still background A (motion vector Va=0) as shown in FIG. 8A, the observation point (human eyes) moves along this arrow. Since the subfield lighting position related to the pixel on the object B having the motion vector Vb is corrected at that time, an image from which the pseudo profile is removed can be obtained. However, the motion vector Va=0 for the background image A, and the lighting position of the subfields is not corrected. And as a result, the movement of the observation point is opposed, and a pseudo profile is observed in the peripheral region C of the observation point of the background image.

Consequently, as shown in FIG. 8B, a motion vector Vc (=Vb) similar to the observation point is given to the background region C near the observation point. This can be realized by applying a low-pass filter to the spatial distribution of the motion vector, and the motion vector Vb of the object B can be expanded to the peripheral region C of the observation point. As a result, the pseudo profile that develops in the background region C in the periphery of the observation point can be removed. Since the human observation point is limited to the periphery of removing objects, it is not necessary to correct distant background images.

Furthermore, in this embodiment, it is possible to control the low-pass filter 29 according to the magnitude of the moving object. The magnitude of the object is calculated by the result obtained by the histogram counting module 26, and the low-pass filter 29 is switched ON and OFF after comparing the maximum count value with the threshold value S. The human visual characteristic is such that the observation points are mostly limited within the moving object when the object moving in the frame is large and it is not sensitive to the movement of pixels in the periphery. When the moving object is small, the observation point extends sometimes to pixels in the periphery of the object. Therefore, by switching the filter ON when the object size is small, and by switching the filter OFF when the size is large, it is possible to reduce more effectively the pseudo profile by adapting to the visual characteristic.

### Third Embodiment

FIG. 9 is an illustration showing still another example configuration of the image processing module in FIG. 1. This embodiment represents a configuration wherein the histogram counting module 26 constituting the image processing module 2 of the first embodiment (FIG. 2) is replaced by a scrolling detecting module 30. When the whole frame is moving in the same direction (scrolling operation), the motion vectors in relation to all the pixels in the frame are arranged in such a way that they will be identical to the motion vector of the scrolling movement.

The scrolling detecting module 30 determines whether the image signals inputted through the terminal 21 are scrolling images or not, and if they are scrolling images, it detects the motion vector Vs corresponding to the scrolling movement. The scrolling detecting module 30 can be realized by using the publicly known arts. For example, when motion vectors of the predetermined size are detected for the predetermined frequency or more frequently after storing the motion vectors of various pixels within the frame in the buffer, the existence of scrolling movement can be determined.

With regards to the images of which a scrolling movement has been detected, the motion vector correcting module 25 performs the processing for replacing the motion vector V detected by the motion vector 24 by the motion vector Vs detected by the scrolling detecting module 30. Then, the subfield correcting module 23 corrects the subfield lighting position according to the corrected motion vector Vs.

This correcting processing enables the correction of lighting positions of small objects in the same direction as the peripheral region even if the scrolling image contains pixels (including small objects) moving in a different way from the scrolling movement, and therefore no pseudo profile develops.

### Fourth Embodiment

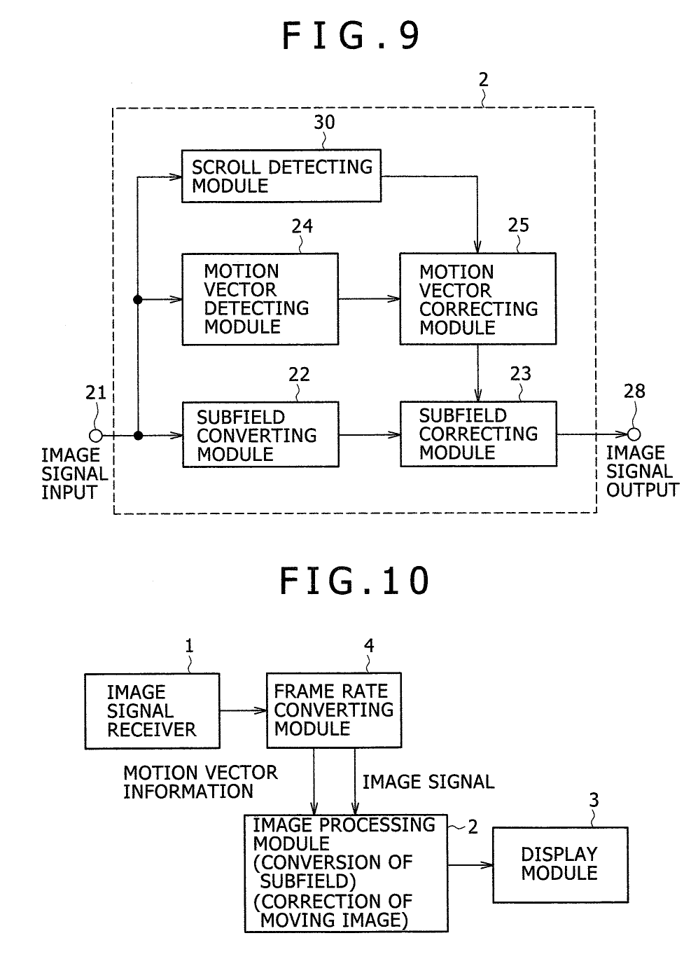

FIG. 10 is a block diagram showing another embodiment of the image display apparatus according to the present invention. Its configuration represents the addition of a frame rate converting module 4 to the configuration of the image display apparatus according to the first embodiment (FIG. 1). The frame rate converting module 4 is a circuit for converting the frame rate of the image signals received by an image signal receiver 1, and has a function of converting for example 60 Hz to 120 Hz. At that time, the frame rate converting module 4 prepares interpolation image frames corresponding to the movement among image frames, and therefore contains the processing for calculating the motion vector information in the process thereof.

In this embodiment, taking advantage of the motion vector information calculated by the frame rate converting module 4, the image processing module 2 corrects moving images. In other words, the motion vector detecting module 24 described in the first embodiment (FIG. 2) is no longer necessary, and this embodiment has the effect of simplifying the configuration of the whole image display apparatus. This can be applied in the same way to the second embodiment (FIGS. 8A and 8B) and the third embodiment (FIG. 9).

While we have shown and described several embodiments in accordance with our invention, it should be understood that the disclosed embodiments are susceptible of changes and modifications without departing from the scope of the invention. Therefore, we do not intend to be bound by the details shown and described herein but intend to cover all such changes and modifications that fall within the ambit of the appended claims.

What is claimed is:

1. An image processing method for displaying multiple tone images in a subfield light-emitting type display module, wherein:
a frame is divided into a plurality of subfields in a time-sharing manner, and is converted into a subfield light-emitting pattern corresponding to the luminosity level of the input image signal;
the motion vectors of pixels among frames relating to the input image signals are detected;
the light-emitting positions of the subfield light-emitting pattern are corrected according to the motion vectors detected; and
when the distribution of the motion vectors V in the frame is biased to a specific motion vector Vm, the motion vectors V of all the pixels in the frame are replaced by the specific motion vector Vm and then the light-emitting positions of the subfield light-emitting pattern is corrected.

2. The image processing method according to claim 1,
wherein the histogram of the motion vectors V detected in the frame is calculated, and if the count number of motion vectors V is equal to the threshold value S or more, the motion vector is determined to be the specific motion vector Vm.

3. The image processing method according to claim 1,
wherein the presence of scrolling movement in the frame is detected from the input image signal, and if the scrolling movement is detected, the motion vector corresponding to the scrolling movement is determined to be the specific motion vector Vm.

4. An image processing method for displaying multiple tone images in a subfield light-emitting type display module wherein:
a frame is divided into a plurality of subfields in a time-sharing manner, and is converted into a subfield light-emitting pattern corresponding to the luminosity level of the input image signal;
the pixel motion vectors among frames relating to the input image signals are detected;
a spatial low-pass filter processing is implemented on the detected motion vector; and
the light-emitting position of the subfield light-emitting pattern is corrected according to the motion vector on which the low-pass filter processing is implemented.

5. An image display apparatus for displaying multiple tone images in a subfield light-emitting type display module comprising:
a subfield converting module which divides a frame into a plurality of subfields in a time-sharing manner, and converts the same into a subfield light-emitting pattern corresponding to the luminosity level of the input image signal;
a motion vector detecting module which detects the motion vector of pixels among frames relating to the input image signal;
a motion vector correcting module which replaces the motion vector V of all the pixels in the frame with the specific motion vector Vm when the distribution of the motion vectors V in the frame detected by the motion vector detecting module is biased to the specific motion vector Vm; and
a subfield correcting module which corrects the light-emitting position of the subfield light-emitting pattern converted by the subfield converting module according to the motion vector outputted by the motion vector correcting module,
wherein the subfield light-emitting pattern corrected by the subfield correcting module is supplied to the display module.

6. The image display apparatus according to claim 5 comprising:
a histogram counting module which counts the histogram of motion vectors V in the frame detected by the motion vector detecting module; and
wherein the motion vector detecting module determines that the motion vector is the specific motion vector Vm if the count number of the motion vector V is equal to the threshold value S or more by referring the histogram, and replaces the motion vector of all the pixels in the frame with the specific motion vector Vm.

7. The image display apparatus according to claim 5 comprising:
a scrolling detecting module which detects whether there is any scrolling movement in the frame from the input image signal,
wherein the motion vector detecting module determines that the motion vector corresponding to the scrolling movement is the specific motion vector Vm if the scrolling detecting module has detected any scrolling movement and replaces the motion vector V of all the pixels in the frame with the specific motion vector Vm.

8. An image display apparatus for displaying multiple tone images in a subfield light-emitting type display module comprising:
a subfield converting module which divides a frame into a plurality of subfields in a time-sharing manner, and converts the same into a subfield light-emitting pattern corresponding to the luminosity level of the input image signal;
a motion vector detecting module which detects the motion vector of pixels among frames relating to the input image signal;
a filter for implementing a spatial low-pass filter processing on the motion vectors detected; and
a subfield correcting module which corrects the light-emitting position of the subfield light-emitting pattern according to the motion vector on which the filter implemented low-pass filter processing,
wherein the subfield light-emitting pattern corrected by the subfield correcting module is supplied to the display module.

9. The image display apparatus according to claim 5 comprising:
a frame rate converting module which converts the frame rate of the input image signal,
wherein the motion vector detecting module uses the motion vector information calculated by the frame rate converting module.

10. The image display apparatus according to claim 8 comprising:
a frame rate converting module which converts the frame rate of the input image signal,
wherein the motion vector detecting module uses the motion vector information calculated by the frame rate converting module.
